(19) United States
(12) Patent Application Publication
(10) Pub. No.: US 2026/0016281 A1
(43) Pub. Date: Jan. 15, 2026

(54) INTERFEROMETRIC RETROREFLECTING SENSOR SYSTEM

(71) Applicant: The Board of Trustees of the Leland Stanford Junior University, Stanford, CA (US)

(72) Inventors: Olav SOLGAARD, Stanford, CA (US); Anne Rebecca KROO, Stanford, CA (US)

(21) Appl. No.: 19/267,130

(22) Filed: Jul. 11, 2025

Related U.S. Application Data
(60) Provisional application No. 63/669,931, filed on Jul. 11, 2024.

(51) Int. Cl. G01B 9/02056; G01B 9/02001; G02B 5/122

(52) U.S. Cl. CPC G01B 9/02059; G01B 9/0201; G02B 5/122

(57) ABSTRACT

A retroreflecting sensor includes a corner cube retroreflector having three mutually orthogonal reflective surfaces. A sensor element is disposed on at least a portion of one of the reflective surfaces. The sensor element modulates a phase and/or an amplitude of incident light as a function of a measurand so that when illuminated by incident light, a diffraction pattern is reflected to a remote optical imaging device configured to capture and analyze the diffraction pattern to extract measurement data associated with the measurand.

### CROSS REFERENCE TO RELATED APPLICATION

This application claims the benefit of U.S. Provisional Application 63/669,931, filed Jul. 11, 2024, entitled “INTERFERMETRIC RETROREFLECTING SENSOR PLATFORM”, the contents of which are incorporated herein by reference.

### BACKGROUND

Corner cubes have emerged as important components in sensing applications due to their ability to enhance signal strength by efficiently redirecting light from a transceiver back to its source. This approach has been investigated to mitigate alignment constraints, thereby facilitating more practical deployable sensors like colorimetric sensors. However, despite the advancements in utilizing corner cubes, there exist significant limitations in sensor compatibility and the absence of a reliable reference mechanism. These shortcomings impede the broader application of corner cube-based sensing technologies, necessitating addressing these challenges.

### SUMMARY

In one aspect, a retroflecting sensor system is presented herein that addresses key challenges associated with the practical deployment of various optical sensors. In some implementations, the platform advantageously features a scalable and compact footprint, eliminates alignment requirements via retroreflection and centralizes a light source (e.g., a laser) to facilitate passive distributed sensors. Moreover, the retroreflecting sensor system enables straightforward readout of phase sensors. These advantages make the retroreflecting sensor system well suited for a wide variety of applications such as thin film chemical sensing, robotics positioning and environmental sensing.

The retroreflecting sensor system described herein is based on corner cube devices, which can be used, for example, to redirect light from a transceiver back to its source. By patterning or otherwise applying a sensor surface onto half of one of the surfaces of a corner cube (three mutually orthogonal surfaces), the returning diffraction pattern is manipulated. The diffraction pattern returning to the transceiver changes as the sensor changes its optical properties with the measurement. When the sensor imparts a phase shift on the outgoing beam from the corner reflector, the beam moves from hexagonal symmetry to clover leaf shaped near four-fold symmetry. When the sensor imparts an amplitude change on the outgoing beam, the beam has one first order center lobe with adjacent side lobes forming a line. This occurs because half of the incident light on the corner cube interacts with the sensor and half interacts only with the reference surfaces. The reference and signal beams are mixed in the diffraction pattern and interfere in such a way that the sensitivity varies sinusoidally like a first order interferometer.

In some implementations, the corner cube devices can be made at the millimeter scale from silicon with standard lithographic processes thus making it inexpensive per unit at scale. With millimeter scale passive retroreflecting sensor systems, the sensors could be distributed in large numbers (e.g., millions) over an arbitrary spatial region and read out from a central base station (land or drone based) at arbitrary temporal steps. This scalability provides significant opportunities for environmental monitoring and the like. In some particular implementations the corner cube devices are fabricated using silicon platform technology. However, the devices may be fabricated in other material-systems as well, including, for example, ice, which can allow monitoring in extreme environments such as the Arctic. In both silicon and ice platforms, these devices can be inert in the environment and made to degrade so as to be indistinguishable from the surrounding environment.

Another application of the sensor platform is in photoacoustic spectroscopy (also called gas-modulation photoacoustic spectroscopy or resonant photoacoustic spectroscopy). In this application, the sensor element is a gas cell in the corner cube. If the gas to be detected is present in the volume between the corner cube and the transceiver, then the light will be absorbed before it reaches the sensor, and no signal will be detected. If the gas is not present in the volume between the base station and the sensor, then the light will be absorbed in the sensor, leading to heating, which in turn leads to changes in the reflected phased and/or amplitude.

An application that requires thin films without sensor functionality, is the creation of corner cubes with specific diffraction patterns such that individual corner cubes can be given a signature diffraction pattern that allows it to be distinguished from other corner cubes. This type of “signature” corner cube can be useful in surveying, satellite communication and other applications where standard corner cubes are used, and in which distinguishability adds value.

The retroreflective sensor platform described herein enables corner cubes with a null in the center of the diffraction pattern. These types of corner cubes can be applied to precision surveying and precision alignment.

In another aspect, the retroreflecting sensor system described herein can enable the use of phase sensors since it makes interferometric measurements as experimentally easy and low cost as amplitude measurements. Instead of a complex interferometric receiver, the change in a diffraction pattern can be utilized, which can be read out with a standard camera. This is particularly important in the field of environmental sensing. This field is currently limited not by the sensor chemistries to measure methane, CO₂, and even environmental DNA for example, but instead is limited by the ability to receive data back from those sensors in sufficient geo-spatial and temporal sampling to be useful.

Other applications in which the retroreflecting sensor system described herein may be employed involve the patterning of corner cubes for localization. By patterning phase or amplitude variations on a surface, unique diffraction patterns can be that could be used for navigation and localization with constant luminosity with respect to distance.

Any desired number of sensor elements can be incorporated into a corner cube and interrogated when used in the present retroreflecting system. For instance, mechanical sensor elements can be configured as Fabry-Perot or other types of optical interferometers may be used. In this case the mechanical measurand, e.g. pressure or acceleration, deforms a mechanical structure that leads to an optical reflective phase shift and/or change in reflection. Temperature sensor elements can be formed from a simple thin film that acts as an optical resonator and changes its thickness, and therefore its reflective phase and/or amplitude, as a function of temperature. Chemical sensors can be configured as thin films that absorb or physisorb a chemical measurand, which creates a change in reflected phase or amplitude. Sensor elements formed from biomolecules can be configured as functionalized surfaces on which the biomolecule to be measured can be bound to the sensor trough biomolecular association with a sensor molecule deposited on the sensor surface, leading to a change in reflected phase and/or amplitude.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this disclosure.

### BRIEF DESCRIPTION OF THE DRAWINGS

FIG. 1 shows a schematic perspective view of one example of a retroreflecting corner cube.

FIG. 2 shows a schematic perspective view of another example of a retroreflecting corner cube constructed in accordance with the present disclosure.

FIG. 3 is a schematic diagram of one example of a system that may be used to read the sensor information from the retroreflecting sensor.

FIG. 4 shows the aperture of a corner cube at normal incidence.

FIG. 5A shows a naming scheme that is used to identify different regions of the 6 equilateral triangles shown in FIG. 4; FIG. 5B shows an alternative naming scheme used to identify different sub-portions of the 6 equilateral triangles that make up the three corner cube surfaces.

FIG. 6A shows the exit pupil for a retroreflecting sensor in which the sensor element is located in regions A1 and A2 and the light is incident on region A1; FIG. 6B shows the exit pupil for a retroreflecting sensor in which the sensor element is located in regions A1 and A2 and the light is incident on region A2; and FIG. 6C shows that when the sensor element is placed in regions A1 and A2 the light interacts with regions A1, A2, C4, B2, B3 and B4.

FIG. 7A show four configurations of the retroreflecting sensor in which the sensor element is located on different portions of the reflecting surfaces of the corner cube; FIG. 7B shows the exit pupil for each of the four configurations shown in FIG. 7A.

FIG. 8A shows the diffraction patterns when the phase imparted by the sensor element is, from left to right, 0, π2, and π; and FIG. 8B shows the diffraction patterns when the change in amplitude imparted by the sensor element is, from left to right, 1, 0.5 and 0.

FIG. 9A shows the resulting quantified change in the diffraction pattern as a function of phase; and, FIG. 9B shows the resulting quantified change in the diffraction pattern as a function of amplitude.

### DETAILED DESCRIPTION

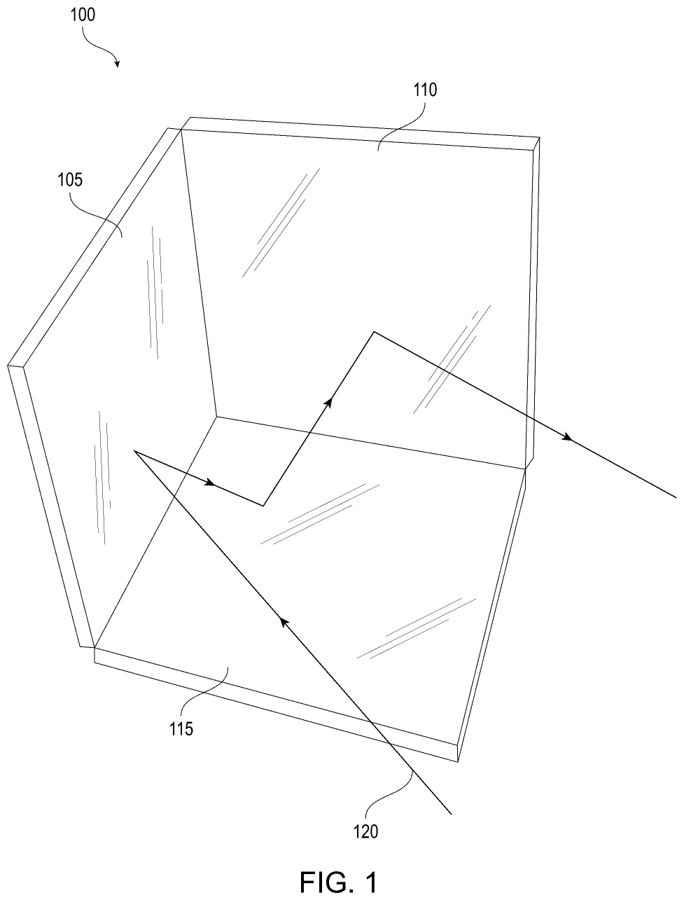

FIG. 1 shows a schematic perspective view of one example of a retroreflecting corner cube 100, which as shown has three orthogonal reflecting surfaces 105, 110 and 115. Also shown is a light ray 120 incident upon one of the surfaces of the retroreflecting corner cube 100, in this case surface 105. After being reflected by surface 105, the light ray 120 is directed to surface 115, which in turn reflects the light ray 120 to surface 110. Surface 110 reflects the light ray 120 back to its source. One notable property of retroflecting corner cubes is that no matter what direction the incident light is received from, or which of the three surfaces it is initially directed upon, the light is always reflected back in the direction of the incident light. That is, the incident light beam and the outgoing light beam are parallel to one another.

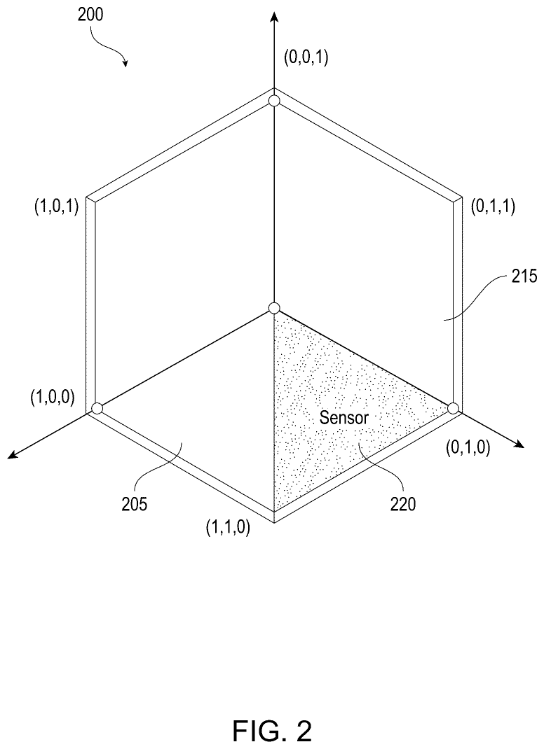

FIG. 2 shows a schematic perspective view of another example of a retroreflecting corner cube 200 constructed in accordance with the present disclosure, which will be referred to herein as a retroreflecting sensor 200. As shown, the retroreflecting sensor 200 has three orthogonal reflecting surfaces 205, 210 and 215. One of the surfaces, in this example reflecting surface 205, has a phase and/or amplitude sensor element 220 disposed on a portion of it. In this example, the sensor element 220 covers one half of the reflecting surface 215. The sensor element 220 may be formed from any material that is patterned or otherwise applied to the surface 205 so that it changes its phase and/or reflectivity as a function of a measurand. As the phase and/or reflectivity of the sensor surface varies relative to the reference surfaces (the surfaces of the retroreflecting sensor that do not include the sensor element), the diffraction pattern undergoes corresponding changes under coherent illumination.

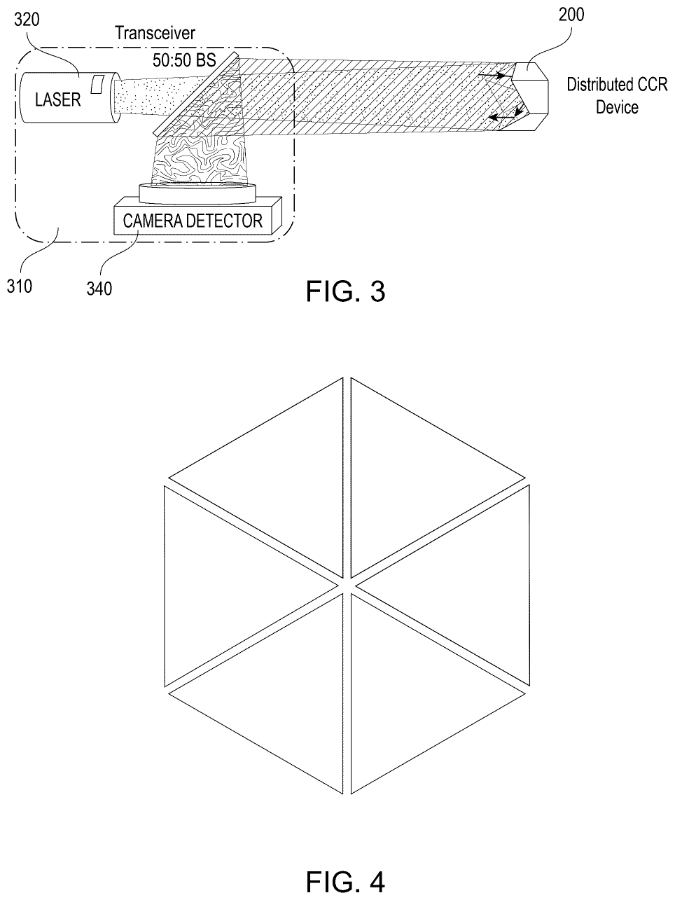

FIG. 3 is a schematic diagram of one example of a system that may be used to read the sensor information from the retroreflecting sensor 200. As shown, a transceiver 310 is provided that includes a light source 320 (e.g., a laser) for generating the light that is directed to the retroreflecting sensor 200 and an imaging device 340 such as a camera for receiving the retroreflected light. The light source 320 illuminates the aperture of the retroreflecting sensor 200, exploiting its retroreflective nature to ensure that the light is redirected back toward the transceiver. The returning diffraction pattern is captured by the imaging device 340. A beamsplitter 350 is arranged in the optical path between the transceiver 310 and the retroreflecting sensor 330 to redirect the returning diffraction pattern to the imaging device 340.

It should be noted that the retroreflecting sensor 200 shown in FIG. 2 is only one illustrative example of a retroreflecting sensor constructed in accordance with the present disclosure. More generally, for instance, the size, shape and location of the sensor element may vary from that depicted in FIG. 2 and may be chosen based on the application for which retroreflecting sensor is to be used. Moreover, in some embodiments, instead of a single sensor element, multiple sensor elements may be arranged on two or more different surfaces of the corner cube. The different sensor elements may all be of the same type or they may differ in order to sense different measurands. However, for simplicity and clarity of illustration the following analysis will focus on a retroreflecting sensor having a triangular sensor clement applied to one half of one the surfaces such as shown in FIG. 2.

The far field diffraction patterns obtained from the retroreflecting sensor shown in FIG. 2 may be determined by first modeling the three-dimensional retroreflecting sensor. In modeling this three-dimensional system, some simplifying assumptions may be made. It has long been understood that a standard hollow corner cube has a flat phase response by geometric arguments such as those seen for example, in Russell A. Chipman, Joseph Shamir, H. John Caulfield, and Qi-Bo Zhou, “Wavefront correcting properties of corner-cube arrays,” Appl. Opt. 27, 3203-3209 (1988) and Marija S. Scholl, “Ray trace through a corner-cube retroreflector with complex reflection coefficients,” J. Opt. Soc. Am. A 12, 1589-1592 (1995). This means that the retroreflecting sensor can be modeled as a two-dimensional diffraction grating. As shown in FIG. 4, at normal incidence, this grating has a hexagonal aperture 400 that is divided into 6 equilateral triangles 410₁-410₆.

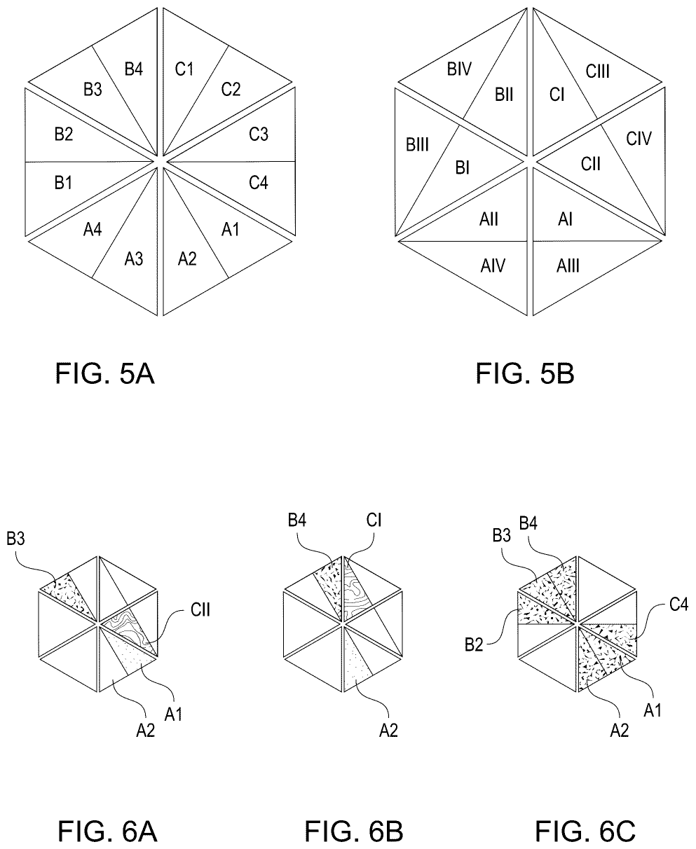

FIG. 5A shows a naming scheme that will be used hereinafter to identify different regions of the 6 equilateral triangles shown in FIG. 4. FIG. 5B shows an alternative naming scheme that also will be used hereinafter to identify different sub-portions of the 6 equilateral triangles that make up the three corner cube surfaces. These naming schemes, which define the various exit pupil regions of the retroreflecting sensor, will be used to determine the near field patterns of the retroreflecting sensor.

To determine which exit pupil regions cause the incoming light to be incident upon the sensor element and which do not, a non-sequential 3d ray tracing algorithm may be used. At normal incidence two cases may be observed with this ray tracing algorithm, which allows an intuitive model to be developed illustrating how the retroreflecting sensor functions.

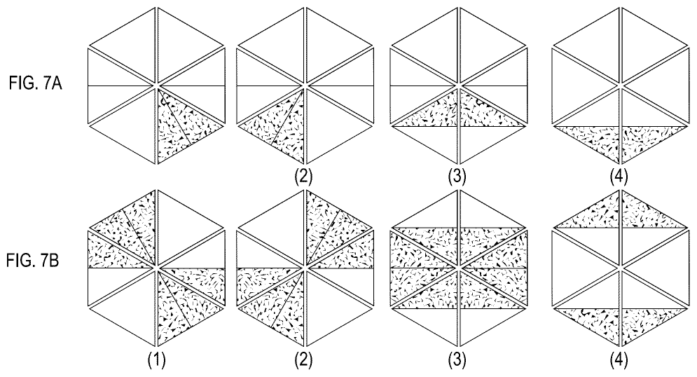

The first case is shown in FIG. 6A. In this example the sensor element is assumed to be located on surfaces A1 and A2. If light is incident on surface A1 it will bounce intermediately on surface CII before exiting the corner cub system from surface B3. Since the sensor is located on surfaces A1 and A2, the light exiting surface B3 will have interacted with the sensor element. By symmetry, the same argument can be made for surface C4 which has an intermediate bounce on AI, thus interacting with the sensor element before exiting from surface B2.

The second case is shown in FIG. 6B. In this example, light incident on surface A2 will interact with the sensor element, undergo an intermediate bounce on surface CI and exit from surface B4. By reciprocity light exiting A1, B3, C4, B2, A2, and B4 will all have interacted with the sensor element. All other equilateral triangles in the naming scheme of FIG. 5 will not have interacted with the sensor. Thus, 6 of the 12 equilateral triangles, or half of the returning light beam, will have the sensor information encoded in it and half will not. FIG. 6C shows that when the sensor element is placed in regions A1 and A2 the light interacts with regions A1, A2, C4, B2, B3 and B4.

This analysis demonstrates one of the four locations that a triangular sensor element may occupy in the retroreflective corner cube. FIG. 7A shows 4 retroreflecting sensor configurations (1)-(4), with the triangular sensor element being disposed in different locations, as indicated by the lightly shaded triangular regions. FIG. 7B shows the corresponding exit pupil for each retroreflecting sensor configuration shown in FIG. 7A, where the lightly shaded regions depict those regions that retroreflect light with sensor information.

Using the same intuitive ray tracing approach, it can be shown that retroreflecting sensor configurations 1 and 2 in FIG. 7A are identical. Retroreflecting sensor configurations 3 and 4 result in the exit pupils shown in FIG. 4B. In configuration 3, ⅔rds of the aperture interacts with the sensor element while in configuration 4, ⅓^{rd} of the aperture interacts with the sensor element.

Each of the sensor element locations shown in FIG. 7A have applications in which they outperform the others. For instance, configuration 1 may be preferred if the sensor element changes the phase of the reflected light but has the same reflectivity as the reference surface. This is because the interference of the phase shifted and non-phase shifted portions of the returning light beam is maximized when they are equal in amplitude. The reference surfaces can be plain mirrors or non-functionalized reference surfaces that may be used to compensate for confounding environmental parameters such as temperature. The sensor can be deposited in other configurations on the corner reflector beyond a triangular sensor area and still impact the diffraction pattern. In some applications, depositing sensors on multiple surfaces is advantageous to increase the sensitivity so that some of the exiting light has hit two sensor surfaces. Although the following discussion with primarily discuss configuration 1 as being used for phase detection, the same processes can be used for the other three depicted configurations as well as arbitrary sensor locations.

From the aforementioned ray tracing system, the Fraunhofer diffraction integral can be used to obtain the far field diffraction pattern of the retroreflecting sensor by taking the Fraunhofer diffraction of each of the 12 triangular regions surfaces shown in FIG. 5A by applying a phase or amplitude shift based on whether the triangular region in the exit pupil interacted with the sensor element and then summing the resulting patterns. The far field diffraction pattern of the retroreflecting sensor may be represented by the following equation:

$$D = \frac{1}{R} {\sum }_{n = 1}^{12} {A}_{n} {e}^{i {θ}_{n}} \int {\int }_{t r {i}_{n}} {e}^{\frac{i k ( X x + Y y )}{R}} dxdy$$

where k is the propagation vector which is taken to be

$$k = \frac{2 π}{λ} ,$$

X and Y are the coordinates in the far field plane, R is the distance from the aperture to the diffraction plane, and x and y are the near field plane that is integrated over the triangular subdivision surface. Additionally, A is the amplitude shift and θ is the phase shift for the given triangular subdivision surface, which is applied if the light exiting from that triangular subdivision surface has interacted with the sensor in the ray tracing analysis. We have demonstrated this system with triangular subdivisions, however other subdivisions may be used with the same methodology.

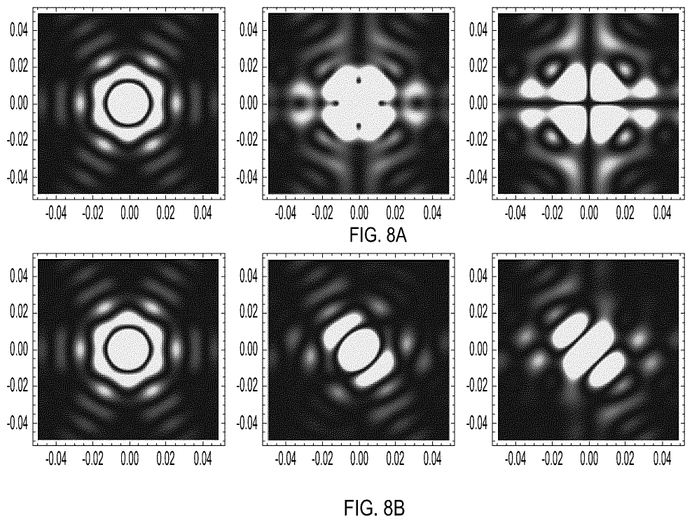

FIG. 8A shows the diffraction patterns when the phase imparted by the sensor element is, from left to right, 0, π/2, and π. FIG. 8B shows the diffraction patterns when the change in amplitude imparted by the sensor element is, from left to right, 1, 0.5 and 0. Thus, for example, when the sensor surface imparts both a phase and a reflected amplitude change that is equal to the reference surface, the result is the left-most diffraction patterns shown in FIGS. 7A and 7B. In these diffraction patterns, the light beam is assumed to be much larger than the aperture of the corner cube, thus assuming uniform illumination across the corner cube.

When a phase shift is provided by the sensor surface, the symmetry changes from hexagonal to primarily square with some lingering hexagonal artifacts from the aperture of the corner cube as seen in FIG. 8A. This occurs because the phase shifted triangular surface subdivisions in the exit pupil introduce a square symmetry in this plane.

To determine the sensitivity (s(θ)) of the retroreflecting sensor described herein the derivative of the diffraction pattern is taken with respect to angle and then X and Y are integrated to quantify the total change in the entire diffraction pattern. Mathematically this is represented as:

$$s ( θ ) = \int \int \frac{d}{d θ} ( D ( X , Y , θ ) ) dXdY$$

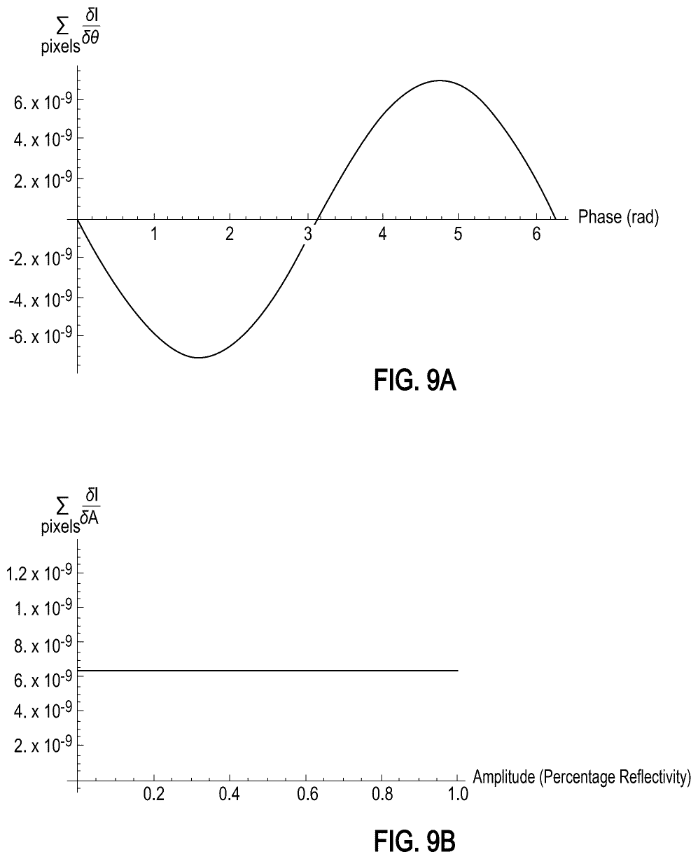

FIG. 9A shows the resulting quantified change in the diffraction pattern as a function of phase. Likewise, FIG. 9B shows the resulting quantified change in the diffraction pattern as a function of amplitude. As FIG. 9A shows, the sensitivity of the system is indicative of a first order interferometer, demonstrating that the system described herein serves as an interferometric sensor. Because the diffraction pattern is being obtained instead of information from a single photodetector, additional information can be obtained from the captured diffraction patterns.

When a change in reflectivity is imparted by the sensor surface, the symmetry also changes, but in a different manner. As shown in FIG. 8B, the first orders of the diffraction pattern collapse from hexagonal symmetry to a two-fold line-based symmetry, again with artifacts from the outer aperture.

The sensitivity s(A) can similarly be determined by taking the derivative of the diffraction pattern with respect to reflected amplitude and then integrated across X and Y, which is mathematically represented as:

$$s ( A ) = \int \int \frac{d}{d A} ( D ( X , Y , θ ) ) dXdY$$

This results in a constant sensitivity, demonstrating that the diffraction pattern changes linearly with amplitude as seen in FIG. 8B

When operating off normal incidence, the same principle applies, although the diffraction patterns look different and the overall sensitivity is reduced since it is not guaranteed that half of the incident light interacts with the sensor element. The sensor information is still extractable, however, because changing the angle of incidence of the corner cube changes the diffraction pattern in a different way than changing the sensor surface amplitude or phase. The change in diffraction pattern with respect to angle has been well described in various references including, for example, Thomas W. Murphy and Scott D. Goodrow, “Polarization and far-field diffraction patterns of total internal reflection corner cubes,” Appl. Opt. 52, 117-126 (2013). The retroreflecting sensor described herein can address some of the key challenges with using thin film or patterned sensors in a practical field deployment. While optical thin film sensors scale in manufacturing, they are made expensive and bulky as a result of the packaging and peripherals that are required. Additionally, the cross sensitivity of optical thin film sensors to environmental factors such as angle and temperature require precise alignment and control or additional reference sensors. The retroreflecting sensor described herein allows low cost deployment of thin film sensors by eliminating packaging and alignment constraints and allowing for the extraction of environmental factors by including a reference mechanism.

Additionally, the retroreflecting sensor described herein enables the use of phase sensors because it makes interferometric measurements as easy to obtain as amplitude measurements, and at equally low cost. Instead of using a complex interferometric receiver, the change in a diffraction pattern that can be read out with a standard camera can be used.

This simplification in making interferometric measurements can be particularly important when used for environmental sensing. This field is currently limited not by the sensor chemistries to measure methane, CO₂, and even environmental DNA, for example, but is limited instead by the ability to retrieve data back from the retroreflecting sensor with sufficient geo-spatial and temporal sampling to be useful.

In some embodiments, the retroreflecting sensor described herein can be fabricated from silicon at millimeter scale using conventional lithographic processes thus making it inexpensive per unit at scale. With millimeter scale, passive sensor systems, the retroreflecting sensors can be distributed by dropping any number (e.g., millions) of them over an arbitrary spatial region. The retroreflecting sensors may then be read out from a central base station (land or drone based) at arbitrary temporal intervals. This scalability unlocks a new paradigm for environmental monitoring. In other embodiments, the retroreflecting sensor described herein may be fabricated from materials best suited to the environment in which they are to operate. For instance, retroreflecting sensors may be fabricated from ice for monitoring in extreme environments such as the Arctic. When fabricated in both silicon and ice material systems, these retroreflective sensors can be inert in the environment and even made to degrade, thus making them indistinguishable from the surrounding environment and consequently not contributing to the environment problems that are being attempted to solve.

One advantage arising from the use of the retroreflective sensor described herein is that it shifts the cost and complexity of sensing from the sensor node to the receiver. Fabrication of the sensor patterned retroreflecting sensors is compatible with silicon fabrication processes, and the devices themselves require no onboard power or electronics. For sensors that require auxiliary power such as heating, a co-located laser of a different frequency may be used to induce the requisite heat or power. All signal interpretation is offloaded to the receiver, decoupling sensing hardware from computational and communication infrastructure. Moreover, a passive optical platform capable of extracting phase from a return image eliminates many barriers stemming from power, deployment and communication infrastructure. A single scanning or moving transceiver can interrogate multiple corner cubes distributed across the environment, enabling scalable, remote readout without embedded electronics.

The retroreflecting sensors described herein may be used in a wide variety of applications. The directional and structural information embedded in the return pattern also opens possibilities beyond sensing. Patterned corner cubes can function as optically addressable fiducials or encoders, useful in applications such as drone geolocation or Simultaneous Localization and Mapping (SLAM). Because the devices are retroreflective, they produce bright, directionally confined signals that can be read at long range with minimal background interference. Their optical brightness falls off linearly with distance, in contrast to the quadratic decay of diffusely scattering tags.

By providing phase or amplitude variations on a surface beyond the simplest triangle “sensor” case primarily discussed, unique diffraction patterns can be made that could be used for navigation and localization with constant luminosity with respect to distance. This application of retroreflector usage has been proposed before (see Gordon T. Uber, “Constant-Luminance Retroreflective Targets For Robot Guidance,” Proc. SPIE 0958, Automotive Displays and Industrial Illumination, (24 Oct. 1988), but previous discussions lack a system that integrates the patterning of unique phase, amplitude, and polarization gratings onto corner cubes. In some applications the retroreflecting sensors may be configured to embed information in the diffraction patterns so that they may be used, for example, as passive augmented reality (AR) codes or tags. Corner cubes have been used in tandem with discrete diffraction gratings (see Chien-Hung Liu Wen-Yuh Jywe, Cha'o-Kuang Chen, W H Hsien, Lih-Horng Shyu, Liang-Wen Ji, Van-Tsai Liu, Tung-Hui Hsu and Chih-Da Chen, “Development of A four-Degrees-of-Freedom Diffraction Sensor” J. Phys.: Conf. Ser. 48 196 (2006)) and for precision alignment, but they have not been integrated together and configured to embed information.

The corner cubes used in the retroreflecting sensors described herein can be made from hollow corner cubes that use mirrors as the reflective surfaces, or solid corner cubes that use total internal reflection on the back surfaces to reflect the light from the three orthogonal surfaces. The sensor patterning can be identical in both, though additional polarization rotations need to be considered when interpreting the diffraction patterns from the solid corner cubes.

Although the applications discussed above only require a single retroreflecting sensor, arrays of retroreflecting sensors also can be used. Individual retroreflecting sensors in an array of different types of retroreflecting sensors can be distinguished from one another by examining their individual diffraction patterns and/or the diffraction patterns from collections of retroreflecting sensors.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of sensing a measurand, comprising;
illuminating with light a corner cube retroreflecting sensor, the corner cube retroreflecting sensor having three mutually orthogonal reflective surfaces and a sensor element disposed on at least a portion of one of the reflective surfaces;
receiving a diffraction pattern formed by retroreflective light retroreflected from the corner cube retroreflecting sensor; and
analyzing the diffraction pattern to extract phase and/or amplitude changes induced by the sensor element, wherein the phase and/or amplitude changes correspond to a value of the measurand.

2. The method of claim 1, wherein the measurand includes one or more environmental parameters.

3. The method of claim 2, wherein sensing the one or more environmental parameters includes sensing a gas or a biological material.

4. The method of claim 1, wherein the measurand includes a geo-spatial or temporal parameter.

5. The method of claim 1, wherein the sensor element occupies a triangular region on a single one of the reflective surfaces.

6. The method of claim 1, wherein the sensor element occupies a specific region on a single one of the reflective surfaces, the sensor region being selected to optimize a specific supplication.

7. The method of claim 5, wherein analyzing the diffraction pattern comprises computing a Fraunhofer diffraction integral over triangular portions of an exit pupil of the corner cube retroreflecting sensor.

8. The method of claim 1, wherein analyzing the modulated diffraction pattern to extract phase and/or amplitude changes includes extracting phase changes that change in a sinusoidal manner or extracting amplitude changes that change in a constant manner.

9. The method of claim 1, wherein the corner cube retroreflecting sensor is configured as a passive optical tag for navigation or augmented reality applications.

10. The method of claim 1, wherein the corner cube retroreflecting integrated sensor enables identification data to be embedded in the retroreflective light.

11. The method of claim 1, wherein the corner cube retroreflecting sensor is part of an array comprising a plurality of corner cube retroreflecting sensors, each having distinct sensor elements allowing individual ones of the corner cube retroreflecting sensors to be distinguished from one another.

12. A retroreflecting sensor, comprising:
a corner cube retroreflector having three mutually orthogonal reflective surfaces;
a sensor element disposed on at least a portion of one of the reflective surfaces, wherein the sensor element modulates a phase and/or an amplitude of incident light as a function of a measurand so that when illuminated by incident light, a diffraction pattern is reflected to a remote optical imaging device configured to capture and analyze the diffraction pattern to extract measurement data associated with the measurand.

13. The retroreflecting sensor of claim 12, wherein the sensor element is a patterned layer.

14. The retroreflecting sensor of claim 12, wherein the sensor element is a thin film layer.

15. The retroreflecting sensor of claim 12, wherein the sensor element occupies a triangular region on a single one of the reflective surfaces.

16. The retroreflecting sensor of claim 12, wherein the sensor element occupies a specific region on a single one of the reflective surfaces, the sensor region being selected to optimize a specific supplication.

17. The retroreflecting sensor of claim 12, wherein the sensor element comprises a plurality of sensor elements, at least two of the plurality of sensor element being disposed on different ones of the reflective surfaces.

18. A sensing system, comprising:
a retroreflector having three mutually orthogonal reflective surfaces forming a corner cube geometry;
a sensor pattern disposed on at least a portion of one of the reflective surfaces, the sensor pattern being configured to modify at least one of phase or amplitude of incident coherent light in response to a measurand;
a light source configured to emit coherent illumination toward the retroreflector; and
a detector configured to capture a diffraction pattern of the retroreflected light, wherein the diffraction pattern contains information indicative of the measurand based on optical interaction with the sensor pattern.

19. The system of claim 18, wherein the sensor pattern comprises a thin film that changes its optical phase shift in response to the measurand or an amplitude-modulating reflective layer that attenuates light intensity based on the measurand.

20. The system of claim 18, wherein the corner cube retroreflector sensor is part of an array comprising a plurality of corner cube retroreflector sensors, each equipped with distinct sensor patterns or properties allowing identification and data extraction from individual ones of the corner cube retroreflector sensors
